(19) United States
(12) Patent Application Publication
(10) Pub. No.: US 2006/0072733 A1
(43) Pub. Date: Apr. 6, 2006

(54) System and method for merchant contact and lead management

(76) Inventors: Paul Ryan, Pasadena, CA (US); Matthew Booth, Pasadena, CA (US); Will Gardenswartz, Laguna Beach, CA (US); Thomas W. Lamb, San Marino, CA (US)

Correspondence Address: CHRISTIE, PARKER & HALE, LLP, PO BOX 7068, PASADENA, CA, 91109-7068, US

(21) Appl. No.: 11/210,301

(22) Filed: Aug. 23, 2005

Related U.S. Application Data
(60) Provisional application No. 60/603,732, filed on Aug. 23, 2004.

(51) Int. Cl. H04M 3/42; H04M 3/00; H04M 5/00

(52) U.S. Cl. 379/211.02; 379/265.02

(57) ABSTRACT

A system is used with advertisements or merchant listings that include promotional phone numbers associated with particular merchants. The system includes a database of associations between phone numbers for the particular merchants and their promotional phone numbers. A call tracker is provided that includes a telephone interface that receives calls directed to multiple phone numbers and identifies a phone number called and a calling phone number for the received calls. As the phone number called is one of the promotional numbers, for received calls, the call tracker uses the database to select the merchant phone number associated with the phone number called and routes the call to the selected merchant phone number. The call tracker also adds data identifying the call, including data identifying the time and date of the call, the calling phone number, the phone number called and the merchant phone number to a call log.

### CROSS-REFERENCE TO RELATED APPLICATION(S)

This application claims priority to and the benefit of U.S. Provisional Application No. 60/603,732, filed on Aug. 23, 2004, which is incorporated by reference as if set forth in full herein.

### BACKGROUND OF THE INVENTION

One of the common ways that businesses have attracted customers is by placing ads in various publications, such as newspapers, phone books (e.g., yellow pages) and magazines. Ads are often also placed in other media such as on radio, television, web pages, direct mailings, emails or any other manner of communicating with consumers.

Traditional advertising is often gauged based on the number of consumer impressions, namely, how many customers view a particular ad over a particular period of time. In the case of more recent web page ads, advertising is sometimes gauged by the number of consumers that “click” on ads or, due the high level of interconnectivity and functionality of the Internet, even by actual transactions resulting from clicks on ads. These later techniques, though, are limited to technologies such as the Internet, and are not available for more traditional types of advertising. For example, a dry cleaning merchant may place ads in various publications, but the dry cleaning merchant is unable to determine whether callers to the dry cleaning merchant obtain the dry cleaning merchant's phone number from a newspaper ad, the white pages, the yellow pages or a bus bench.

### SUMMARY OF THE INVENTION

A system is used with advertisements or merchant listings that include promotional phone numbers associated with particular merchants. The system includes a database of associations between phone numbers for the particular merchants and their promotional phone numbers. A call tracker is provided that includes a telephone interface that receives calls directed to multiple phone numbers and identifies a phone number called and a calling phone number for the received calls. As the phone number called is one of the promotional numbers, for received calls, the call tracker uses the database to select the merchant phone number associated with the phone number called and routes the call to the selected merchant phone number. The call tracker also adds data identifying the call, including data identifying the time and date of the call, the calling phone number, the phone number called and the merchant phone number to a call log.

### BRIEF DESCRIPTION OF THE DRAWINGS

FIG. 1 is a block diagram of a system according to an embodiment of the invention.

FIG. 2 is a flow diagram of the process of handling incoming calls according to an embodiment of the invention.

### DETAILED DESCRIPTION OF THE INVENTION

In some respects, the invention relates generally to managing and tracking the performance of ads in providing customer leads to advertisers (merchants) (throughout this description, the term “merchant” is often used generically to describe advertisers, whether the advertiser is selling goods, providing a service, a combination of goods and services or anything else that may be offered to a consumer). In one embodiment, the primary manner of contact between consumers and merchants is by telephone.

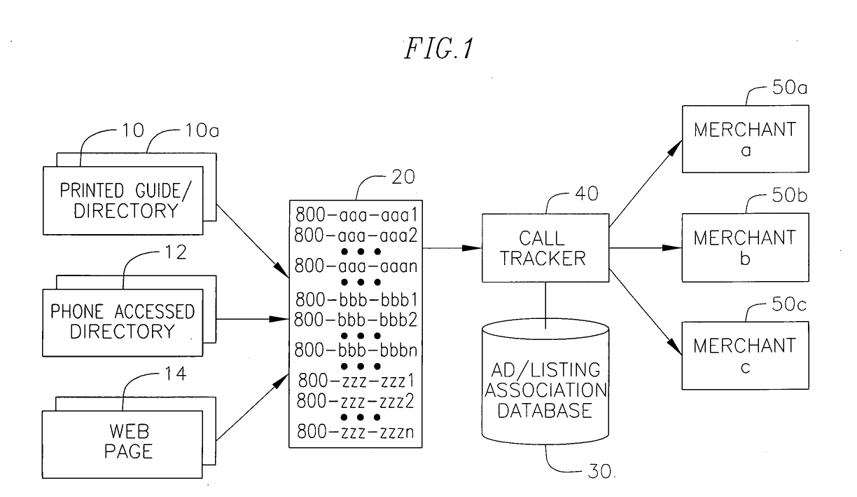

FIG. 1 is a block diagram of system according to an embodiment of the invention. In this system, ads or other referral techniques of various forms are used by merchants. For example, merchant A may place an ad in a printed guide/directory 10. In one embodiment, merchant A's printed ad includes a phone number specific to that printed guide/directory, represented in FIG. 1 as phone number 800-aaa-aaa1 within merchant phone numbers 20. Merchant A may also have an ad in a different printed guide/directory 10a, represented within merchant phone numbers 20 as 800-aaa-aaa2. Merchant A is not limited to the number of ads and corresponding numbers in printed guide/directories. However, as discussed below, the system will track the performance and usage of each different merchant phone number and thus ads with different phone numbers can be tracked separately. Accordingly, the same phone number may be used for the same merchant in multiple publications that are very similar, but calls generated by these publications will be tracked and managed collectively. Conversely, different phone numbers may be used for the same merchant, even in the same publication, if management or tracking differentiating between factors such as ad placement or ad content is desired.

Continuing with FIG. 1, merchant B is included in a phone accessed directory service 12. With the phone accessed directory, a consumer calls a centralized phone number that is answered by a referral service. The consumer provides information as to the type of goods or service they desire as well as additional information, such as location, price range and the like, that may assist in the selection of appropriate merchants for that consumer. Alternatively, the referral service may simply be a 411-type directory service. Based on the information provided by the consumer, one or more merchants are selected and the consumer is given phone numbers or is connected to phone numbers by the phone based directory. The process of collecting information from the consumer and identifying the selected merchant(s) may be provided by the phone based directory using a live person or automation. Returning to merchant B, when phone based directory 12 selects merchant B as a referral, phone based directory provides or uses merchant phone number 800-bbb-bbb1. As with printed guides/directories, merchant B may use more than one referral service, using the same, but typically a different phone number for each referral service.

Merchant B may also have ads or listings that appear on one or more web pages 14. Typically, the phone number on a web page ad or listing, such as 800-bbb-bbb2, will be different than the phone number(s) used with the referral services. Also, multiple phone numbers may be used for web page ads or listings based on such factors as the content of the ad or listing, the site on which they appear, the time or day they appear or any factor identifiable by the computer controlling the placement of the ad or listing.

In another embodiment, other manners of reaching consumers are used other than printed guides/directories, phone based directory services or web pages. In each such case, different phone numbers may be used to differentiate consumer calls placed as result of these different manners.

In the system of FIG. 1, any number of merchants may be involved, each using any one or more of printed guides/directories 10, phone accessed directories 12, web pages 14 or other manner of reaching consumers.

From the information received by the various forms of ads and listings, a consumer will call one of the merchant phone numbers 20. It is noted that while in FIG. 1 all of the merchant phone numbers are toll-free 800 phone numbers, any type of phone number may be used. As described above, each of the merchant phone numbers 20 are associated with a particular merchant. These associations are included in ad/listing association database 30.

Calls to each of the merchant phone numbers 20 are received by call tracker 40, which will be discussed in further detail below. Call tracker 40 is connected to ad/listing association database 30 and based on the stored associations, connects the received call to the merchant 50a-c associated with the merchant phone number of the received call. Typically, the calls will be forwarded to the merchant's pre-existing telephone line(s). Alternatively, the merchant uses a dedicated phone line that only receives consumer calls from call tracker 40.

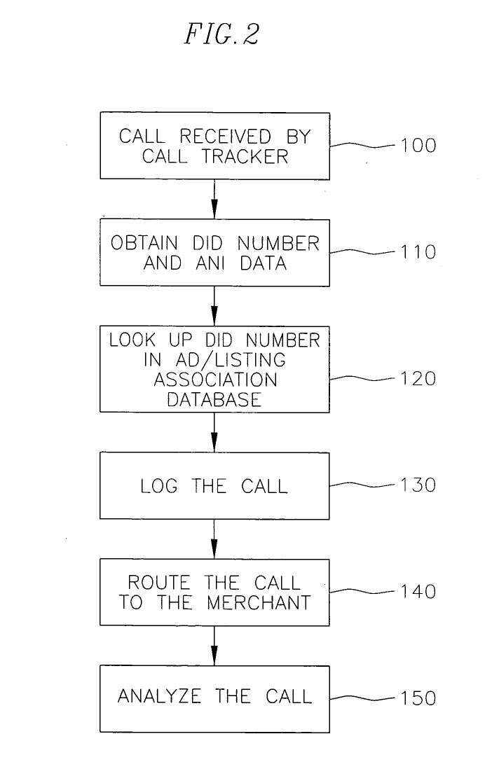

Turning to the operation of call tracker 40, FIG. 2 shows a flow diagram of this operation, according to an embodiment of the invention. In one embodiment, the various merchant phone numbers 20 are routed to a single PBX (private branch exchange) system. Alternatively, multiple PBXs are employed. The PBX routes received calls to call tracker 40 that may be implemented as one computer system or multiple coordinated computer systems. In other alternatives, known systems other than PBX systems are used, such as, but not limited to, VoIP (Voice over IP), to receive calls from any of the merchant phone numbers and route them to call tracker 40.

After a call is received by the call tracker, in block 100, the DID (Direct Inward Dialing) data or other data identifying the particular merchant phone number that was used by the consumer to dial the call is obtained from data sent with the call, in block 110. Also in block 110, ANI (Automatic Number Identification) data is obtained from the data sent with the call. ANI data identifies the phone number of the phone used by the consumer to place the call to the merchant phone number. In an alternate embodiment, Caller ID data is used rather than ANI data. Caller ID data, though, while similar to ANI data in some ways, but is often less accurate, less complete and provided later in the call than ANI data for the same call. In other embodiments, other known data sent with the call is used to identify the phone number of the consumer placing the call.

In block 120, the DID data is used to locate the merchant associated with the merchant phone number called using the ad/listing association database 30. The ad/listing association database includes various data regarding the merchant and the merchant phone number for the call, including the merchant's phone number to which the call should be routed and a merchant ID. Next, in block 130, the call is logged, including the time and date of the call, the DID number of the call, the ANI data, the merchant's phone number to which the call is routed, whether the call was successfully connected to the merchant and the duration of the call after routing to the merchant. In one embodiment, the ANI information is used to access a database that associates phone numbers with supplemental data, such as geographical information, social and economic demographic data and the name(s) associated with the phone number, either in phone company, phone directory or other records. The supplemental data is also stored in the log.

In block 140, the call is routed to the merchant's phone. In some embodiments, selected ANI information and information about the consumer from the call tracker is also provided to the merchant as data within the call that is decoded at the merchant′ site or data provided through a computer network, such as on a web site, by email, by fax, by text message, by page, by physical mail or by any other known data communication method.

It is noted that while most of the information logged in block 130 can be done before the call is routed to the merchant, some information, such as call duration cannot be logged until after the call is completed, which occurs after the call is routed. Further, in most cases, it is desirable for the call to be routed to the merchant as quickly as possible so that any delay to the consumer in having the call answered by the merchant due to the processing by the call tracker is minimized or eliminated. Accordingly, in one embodiment, block 130 and block 140 are performed in parallel.

In block 150, the information in the log is analyzed. In contrast to blocks 130 and 140, though, the timing of the analysis in block 150 is often more flexible and in some embodiments takes place minutes, hours or even days after the information is stored in the log. In another embodiment, some analysis is performed immediately after the call while other analysis is performed at various intervals after the call information is logged.

In one embodiment, merchants pay for the ads/listings based on number of consumer impressions that the ads/listings make. In another embodiment, merchants pay for the ads/listings based on the number of calls generated by the ads/listings as tracked by call tracker 40. In the case where different merchant phone numbers for the same merchant are used in different ads/listings or different types of ads/listings, such as web pages, phone accessed directories or printed directories, as discussed above, the associations between different ads/listings and/or ad/listing types are logged by the call tracker. In such cases, merchants may be charged different rates for calls depending on what ad/listing or what type of ad/listing generated the call. For example, for a particular type of merchant, calls generated by phone accessed directories may be more profitable on average than calls generated by web page ads. For other types of merchants, the situation may be reversed. Likewise the cost of generating calls from one type of ad/listing may be higher than another type of ad/listing.

In yet another embodiment, merchants are charged for “leads” which are different than just calls. For example, if after a consumer makes an initial call to a merchant, they make subsequent calls to the same merchant using the same merchant phone number to arrange further details, obtain further information, check on the status of an order or the like, the subsequent phone calls are all part of the same lead. Similarly, a consumer may see more than one ad/listing for the same merchant with different merchant phone numbers and over a period of time call both merchant phone numbers regarding the same transaction or potential transaction. These two separate calls may be considered a single lead.

In analyzing the call log to determine the number of chargeable leads to a particular merchant, a multivariable function is used. The variables used in the function include:
the call history to the merchant, including the average number of calls to the merchant over a period of time, the average number of calls from distinct ANIs over a period of time, the average number of calls to all merchants (or all merchants of a specific type) over a period of time, the average number of calls from distinct ANIs to all merchants (or all merchants of a specific type) over a period of time, the typical distribution of calls to the merchant and the typical distribution of calls to all merchants (or all merchants of a specific type);
the call history of the specific ANI, including the average number of calls from that ANI to that merchant, the average number of calls from other ANIs to that merchant, the average number of calls from that ANI to any merchant, the average number of calls from other ANIs to any merchants (e.g. a higher than average number of calls from the same ANI to one or many different merchants may be a sign of fraudulent calls designed to generate false leads and charges against the merchant), and the geographic location of the ANI (e.g., a call to a dry cleaner from an out of state ANI is unlikely to be a lead);
the category of the merchant's goods and/or services;
the season of the year;
the time of day;
the day of the week;
the date within the month;
economic conditions;
the number of ads/listings (including type) distributed for this merchant phone number; and
the merchant being called.

Other variables not listed above may also be included in the function. The function generally combines a number of separate statistical analyses of individual or combinations of variables, such as averages, variances, standard deviations, covariances, correlation coefficients, and chi-squared tests. In one embodiment, the relative weighting of the separate statistical analyses is dependent on the results of one or more of these statistical analysis. For example, if the system is flooded with calls to a variety of merchants from the same ANI, a trigger in the formula may force the statistical analysis of these calls to reduce the weighting of all of the other statistical analyses to near zero.

The function returns a number between zero and one. A threshold number is determined such that calls or groups of calls that fall above or below the threshold are considered leads while calls or groups of calls that fall on the other side of the threshold are not considered leads. In one embodiment, a secondary threshold is used such that if the function produces a result that is within a certain amount of the primary threshold further analysis, either computerized or by a human is performed, which may result in the reversal of the result using the primary threshold.

In some embodiments, this function is routinely changed. In one of these embodiments, the results of the function itself are analyzed by computer and the function is automatically modified based on the computer analysis. In another embodiment, human analysis is performed on the results of the function to determine the accuracy of the function and to modify the function based on observations of the errors made by the function. In other embodiments, completely different or separately modified functions are used for different types of merchant, different geographic regions or similar global variables. In other embodiments, feedback from consumers and/or merchants regarding which calls related to leads is used in the analysis and modification of the function. It should be recognized that the various embodiments described above, and indeed throughout this description, are often used together rather than exclusively.

In some embodiments, the analysis in block 150 also includes analyzing and collecting data regarding the activities of individual consumers over a variety of merchants. In this way, statistical information is analyzed for that consumer so that additional advertising can be directed to the consumer that is targeted to their likely tastes and interests.

In some embodiments of the invention, merchants are subject to a verification and certification process before they will be allowed to advertise using the system. The verification and certification process includes analyzing data from public sources and databases such as state licensing information, credit analysis, consumer complaints (e.g., claims made to BBB, The Better Business Bureau), independent quality surveys, published reviews, professional or business association memberships, and number of years in business. In a similar manner as used in determining what calls should be classified as leads, for many merchant or merchant categories, the analysis incorporates a function of the various variables related to merchant quality that produces a number between zero and one and certification is based on the result of the function meeting a threshold. In some embodiments, particularly in cases were the result of the function is close to the threshold or for merchants in particular categories, physical inspections of the merchant's goods or facilities or a sampling of their service is conducted and incorporated into the analysis.

In many of these embodiments, the operator of the system provides consumers that use the system to access a merchant a limited guarantee for the goods and/or services of the merchant. In some embodiments, the level of the guarantee varies among the merchants and may depend on factors such as the category of the merchant's good and/or services, the results of the verification and certification process, past guarantee claims made against the merchant, past guarantee claims made against merchants in the same category of goods and/or services and consumer feedback for that merchant. In some cases, no guarantee will be offered for particular merchants or even entire categories of merchants.

In some embodiments, the certification and verification process is repeated periodically for merchants that have previously passed certification and verification and have been using the system. In this “renewal” certification and verification, in addition to the factors and variables discussed above, feedback and ratings from consumers of the system are also incorporated.

As discussed above, the system includes ads/listings in media such as printed guides/directories, phone accessed directories and web pages. In addition, any other known advertising techniques, such as periodical, radio and television advertising, may be used. It is noted that each of these forms of advertising have different life spans. For example, printed guides/directories may be used by consumers for a year or more after publication and any expense on behalf of the publisher, but cannot be changed after publication. Phone accessed directories and typical web page advertising, on the other hand, are momentary impressions, involve continued expense, but can be changed instantaneously. Other forms of advertising, such as periodical, radio and television ads fall in between, with varying degrees of the length of the consumer impression, varying degrees of ongoing expense and varying lead times for changes to the advertisements.

In some embodiments of the invention, merchants are charged based on a predetermined number of calls or leads over a predetermined period of time. For example, a merchant may agree to pay a set amount to receive 15 leads per month for a year. In these embodiments, it typically does not matter what the source of the lead is (e.g., printed guide versus web page ad), but rather the number of leads over predetermined periods of time. In the embodiment in FIG. 1, leads may come from printed guides/directories, phone assisted directories and web page ads. Due to the nature of printed guides/directories, as discussed above, the operator of the system will not be able to adjust or change the content or circulation of the printed guides/directories in the short term. Accordingly, once the printed guides/directories are printed and circulated, they will produce a largely uncontrollable and somewhat unpredictable frequency of leads for a particular merchant. The frequency of leads from phone accessed directories and web page ads, on the other hand, can be adjusted in close to real time for any particular merchant by adjusting how many time the merchant is chosen for phone assisted directory referrals or how many web page ads are placed for the merchant.

In a generic system, referrals from a phone accessed directory will be based, in a process similar to the analysis of when a call is a lead described above, on a function of several variables, including one or more of: the correlation of the goods and/or services desired by the consumer and those offered by the merchant, the merchant's quality rating, the existence and level of a guarantee offered by the operator of the system, and the proximity of the merchant to the consumer (the weighting of this factor may depend greatly on the category of goods and/or services). Similarly, the selection of ads for placement on a web page will be based on a function of several variables, including one or more of: the correlation of the goods and/or services offered by the merchant and the content of the web page or search terms used by the consumer, the merchant's quality rating, the existence and level of a guarantee offered by the operator of the system, and information about the consumer derived from, for example, cookies, including the proximity of the merchant to the consumer (if this can be determined).

In the embodiment of FIG. 1, the functions for determining phone accessed directory referrals and web page ad selection also include an analysis of the number of leads already provided for the various merchants, the number of leads guaranteed for the various merchants and the price paid for such leads by individual merchants. More specifically, in some embodiments, for each merchant, a calculation is made based on the number of leads already provided, the number of leads guaranteed to be provided but not yet provided, the length of time remaining to provide the guaranteed leads, the length of time in which the leads already provided were provided, the amount that the merchant paid for the guaranteed leads, and the number of not yet provided leads to other merchants in the merchant's category. In an alternate embodiment, the calculation based on these factors includes calculations of a present value liability of unprovided leads for each merchant based on a modified discounted cash flow analysis. Using this analysis the liability for not providing one lead to a merchant with only a short amount of time until the end of the guarantee period may be greater than the liability for not providing a lead to another merchant with more time until the end of its guarantee period. In such embodiments, the comparative liability to the operator for not providing a lead to one merchant versus another merchant is included in the functions to determine the referrals given by a phone accessed directory and the selection of ads for placement on a web page.

Although this invention has been described in certain specific embodiments, those skilled in the art will have no difficulty devising variations to the described embodiments that in no way depart from the scope and spirit of the present invention. Furthermore, to those skilled in the various arts, the present invention itself will suggest solutions to other tasks and adaptations for other applications. It is the applicants' intention to cover by claims such uses of the invention and changes and modifications that could be made to the embodiments of the invention herein chosen for the purpose of disclosure without departing from the spirit and scope of the invention. Thus, the embodiments of the invention described should be considered in all respects as illustrative and as examples of implementations of the invention and not restrictive or as limitations to the scope of the invention. Rather, the scope of the invention is to be determined by the appended claims and their equivalents rather than the foregoing description.

What is claimed is:

1. A system for use with advertisements or merchant listings including promotional phone numbers comprising:
a database comprising associations between merchant phone numbers and promotional phone numbers;
a call tracker comprising a telephone interface that receives calls directed to multiple phone numbers and identifies a phone number called and a calling phone number for the received calls, wherein the call tracker is connected to the database and configured to, for each of a plurality of the received calls,
search the database to select one of the merchant phone numbers such that the selected merchant phone number is associated with the promotional phone number that is correlated to the phone number called,
route the call to the selected merchant phone number, and
add data identifying the call, including data identifying the time and date of the call, the calling phone number, the phone number called and the merchant phone number to a call log.

2. The system of claim 1, wherein the data identifying the call further includes the duration of the call.

3. The system of claim 1, wherein the call tracker is further configured to analyze the data stored in the call log to determine a number of distinct consumer leads represented in the call log for a particular one of the merchants.

4. The system of claim 1, wherein the analysis of the data stored in the call log includes analyzing a plurality of the group consisting of: a call history of the merchant, a call history of a calling phone number, a category of the merchant's goods or services, a call history of other merchants for the category of the merchant's goods or services, a season of the year, a time of day, a day of the week, a date, a rating of the current economic conditions, and an identification of the number and type of advertisements and merchant listings that have been distributed with promotional phone numbers associated with the merchant's phone number.

5. The system of claim 1 further comprising a computer system, connected to the call tracker, configured to:
analyze consumer information including words indicative of a consumer's interest,
correlate the consumer information with data regarding a plurality of merchants, and
identify an advertisement for or referral to one or more of the plurality of merchants based on the analysis and correlation performed by the computer system.

6. A method for use with advertisements or merchant listings including promotional phone numbers that are associated with merchant phone numbers comprising:
receiving calls directed to multiple phone numbers;
identifying a phone number called and a calling phone number for the received calls; and
for each of a plurality of the received calls:
identifying the merchant phone number associated with the phone number called,
routing the call to the identified merchant phone number, and
adding data identifying the call, including data identifying the time and date of the call, the calling phone number, the phone number called and the merchant phone number to a call log.

7. The method of claim 6, wherein the data identifying the call further includes the duration of the call.

8. The method of claim 6 further comprising analyzing the data stored in the call log to determine a number of distinct consumer leads represented in the call log for a particular one of the merchants.

9. The method of claim 6, wherein analyzing the data stored in the call log includes: analyzing a plurality of the group consisting of: a call history of the merchant, a call history of a calling phone number, a category of the merchant's goods or services, a call history of other merchants for the category of the merchant's goods or services, a season of the year, a time of day, a day of the week, a date, a rating of the current economic conditions, and an identification of the number and type of advertisements and merchant listings that have been distributed with promotional phone numbers associated with the merchant's phone number.

10. The method of claim 6 further comprising:
analyzing consumer information including words indicative of a consumer's interest,
correlating the consumer information with data regarding a plurality of merchants, and
identifying an advertisement for or referral to one or more of the plurality of merchants based on the analysis and correlation.

11. A system for use with advertisements or merchant listings including promotional phone numbers comprising:
means for storing associations between merchant phone numbers and promotional phone numbers;
means for receiving calls directed to multiple phone numbers, wherein the means for receiving calls is connected to the means for storing and identifies a phone number called and a calling phone number for the received calls, and, for each of a plurality of the received calls:
searches the database to select one of the merchant phone numbers such that the selected merchant phone number is associated with the promotional phone number that is correlated to the phone number called,
routes the call to the selected merchant phone number, and
adds data identifying the call, including data identifying the time and date of the call, the calling phone number, the phone number called and the merchant phone number to a call log.

12. The system of claim 11, wherein the data identifying the call further includes the duration of the call.

13. The system of claim 11, wherein the means for receiving calls further analyzes the data stored in the call log to determine a number of distinct consumer leads represented in the call log for a particular one of the merchants.

14. The system of claim 11, wherein the analysis of the data stored in the call log includes analyzing a plurality of the group consisting of: a call history of the merchant, a call history of a calling phone number, a category of the merchant's goods or services, a call history of other merchants for the category of the merchant's goods or services, a season of the year, a time of day, a day of the week, a date, a rating of the current economic conditions, and an identification of the number and type of advertisements and merchant listings that have been distributed with promotional phone numbers associated with the merchant's phone number.

15. The system of claim 11 further comprising:
means for analyzing consumer information including words indicative of a consumer's interest,
means for correlating the consumer information with data regarding a plurality of merchants, and
means for identifying an advertisement for or referral to one or more of the plurality of merchants based on the analysis and correlation performed by the means for analyzing and the means for correlating.
